(19) United States
(12) Patent Application Publication
(10) Pub. No.: US 2003/0029288 A1
(43) Pub. Date: Feb. 13, 2003

(54) Apparatus for trimming metal

(76) Inventors: Sergey Fedorovich Golovashchenko, Beverly Hills, MI (US); Laurent Bernard Chappuis, Grosse Pointe Park, MI (US); Guenther Baumann, Chicago Hgts, IL (US); Rudy Regelin, Flossmoor, IL (US); Gary Masak, Valparaiso, IN (US); Richard R. Weir, Toledo, OH (US); William Steven Stewart, Dearborn, MI (US)

Correspondence Address: KEVIN G. MIERZWA, ARTZ & ARTZ, P.C., 28333 TELEGRAPH ROAD, SUITE 250, SOUTHFIELD, MI, 48034, US

(21) Appl. No.: 09/927,281

(22) Filed: Aug. 10, 2001

(51) Int. Cl. B26D 1/06

(52) U.S. Cl. 83/13; 83/694

(57) ABSTRACT

An apparatus for trimming scrap from a blank 10 is provided including a clamping pad 12 holding a blank 14 against a steady blade 16. A moving blade 18 with a radius 24 works in combination with a support element 30,in communication with the scrap 26, to reduce defects in the blank 14 associated with the trimming process.

### TECHNICAL FIELD

The present invention relates generally to an apparatus for trimming metal and more particularly to an apparatus for trimming metal that reduces defects.

### BACKGROUND

Modern product design and manufacturing often utilizes a wide variety of materials. Where once low carbon steel predominated, a variety of new materials such as aluminum alloys are now being utilized. These new materials, often are capable of reducing weight, increasing strength and improving product efficiency. Although such alternative materials may provide a variety of benefits in product manufacturing and design, these same materials may present difficulties when subjected to manufacturing processes originally designed for low carbon steel.

One such manufacturing area where difficulties may arise is in trimming operations. Alternative materials such as aluminum alloys can demonstrate different technological behavior due to differences in mechanical and surface properties and mass density when subjected to trimming operations. These difficulties may give rise to defects arising directly from the trimming process or arising from later operations due to effects caused by the trimming process.

One defect known to arise directly from the trimming process is the generation slivers. The generation of slivers, and similar problem finishes, is highly undesirable as such slivers may get attached to the blank surface and distributed to the dies following the trimming operation. The accumulation of slivers on both these dies and the blank surfaces can result in an unacceptable surface finish when the blank is subjected to press operations. The press operations can cause the slivers located on either the dies or the blanks to be forced into the blank surface.

Known systems for dealing with such slivers commonly focus on the removal of the slivers from the dies and the blanks rather than prevention of sliver generation. The removal of slivers from the dies and the blanks can be time-consuming and expensive. Often the cleaning of dies requires the interruption of automated stamping processes, which is highly undesirable. Furthermore, close visual inspection of a part surface finish is often required and additional metal work may be required to repair indentations caused by the slivers. These processes add to the cost and time of product manufacture and may lead to an increase in the number of parts that must be scrapped if repair is not feasible.

Another approach to the elimination slivers, has been to attempt to increase the accuracy of the alignment of the upper and lower trimming steels. One such standard, that attempts to reduce the problem, requires the gap between the shearing edges to be 10% of the material thickness or less. This standard, however, can translate into gaps of less than 0.1 mm for some sheet metals. Other approaches have further limited the gap to even smaller percentages of material thickness and thereby further decrease the gap. Unfortunately, the tolerances required by such standards often exceed the capabilities of many trim dies and can still result in the production of slivers. This may result in time consuming and expensive procedures that may still fail to eliminate the production of slivers.

A second defect that may arise directly in the trimming operation is the production of burrs. Burrs are known to decrease the quality and accuracy of stamped parts and are the sources of potential splits in following operations. Again, current standards attempt to limit the production of burrs through accurate alignment of the upper and lower trimming steels. These standards attempt to minimize the gap between the shearing edges to 10% of the material thickness. Other methods suggest even smaller reduction in gap such as 0-5% of the material thickness. Again, such tolerances may be beyond the capabilities of many trim dies.

In addition to those defects arising directly from the trimming operations, defects can arise in later operations such as hemming and flanging operations. These later arising defects often can be traced back to results from the trimming operation. Irregular trim surfaces can result in splits when the trimmed blank is later subjected to hemming or flanging. The production of these post trim defects can add to additional repair and may lead to an increase in the number of parts that must be scrapped if repair is not feasible.

Instead of attempting to repair defects after their production or reduce defects by impractical procedures, it would be more efficient and cost effective to improve the trimming process. A reduction in burr, sliver, and split production would decrease costs, reduce manufacturing time, improve surface finish and reduce scrap. It would, therefore, be desirable to have an apparatus for trimming that reduced the production of defects during the trimming process.

### SUMMARY OF THE INVENTION

It is, therefore, an object of the present invention to provide an apparatus for trimming metal that reduces the generation of defects during operation.

In accordance with the object of the present invention, an apparatus for trimming scrap off a blank is provided. The apparatus for trimming scrap includes a steady blade and a clamping pad. The clamping pad holds a blank against the steady blade. A moving blade, including a radius adapted to reduce defects in the blank, moves past the steady blade to trim scrap off the blank. A support element is in communication with the scrap and is adapted to reduce defects in the blank associated with the trimming process.

Other objects and features of the present invention will become apparent when viewed in light of the detailed description of the preferred embodiment when taken in conjunction with the attached drawings and appended claims.

### BRIEF DESCRIPTION OF THE DRAWINGS

FIG. 1 is an illustration of an embodiment of an apparatus for trimming metal in accordance with the present invention;

FIG. 2 is an illustration of an embodiment of the apparatus for trimming metal shown in FIG. 1 in a post-operation stage;

FIG. 3 is an illustration of an alternate embodiment of an apparatus for trimming metal in accordance with the present invention;

FIG. 4 is an illustration of an alternate embodiment of the apparatus for trimming metal shown in FIG. 3 in a post-operation stage;

FIG. 5 is an illustration of an embodiment of the apparatus for trimming metal shown in FIG. 3, the embodiment illustrating a elastic pad support;

FIG. 6 is an illustration of an embodiment of the apparatus for trimming metal shown in FIG. 3, the embodiment illustrating a hydraulic cylinder support; and

FIG. 7 is an illustration of an embodiment of the apparatus for trimming metal shown in FIG. 3, the embodiment illustrating a spring support.

### DESCRIPTION OF THE PREFERRED EMBODIMENT(S)

Referring now to FIG. 1 which is an illustration of an embodiment of an apparatus for trimming metal in accordance with the present invention. The apparatus for trimming metal 10 includes a clamping pad 12 that secures the blank 14 to be trimmed against steady blade 16. These elements, along with the moving blade 18, are presently used to trim metal in the prior art. When such known systems are used to trim alternate materials such as aluminum alloys, however, an unacceptable generation of material slivers and other defects may occur. In order to minimize sliver, and other defects, prior art processes attempted to minimize the gap 19 between the steady blade 16 and the moving blade 18. However, even upon minimization of the gap 19, also known as trim clearance, the production of slivers may still occur. In addition, as the gap 19 is reduced, often the time and expense of the trimming operation may increase.

The reason for the continued production of slivers in the prior art systems bending of the blank 14 during the trimming operation. This bending creates additional tensile strains near the upper surface 20 of the blank 14 and compressive strains around the lower surface 21. Decreasing the gap 19 can decrease the bending moment but it cannot be eliminated even for zero gap because forces are not concentrated on exactly the shearing edges 22,23, also known as leading edges. This results in the blank 14 cracking first on the upper surface 20. Contact pressure between the moving blade 18 and the blank 14 creates hydrostatic pressure that increases the blanks ductility and prevents its failure where they are in contact. As a result, the cracking starts at a point in the blank 14 not in contact with the moving blade 18. In the prior art, this creates a small tongue between the cracking and the sharp edge of the moving blade (not shown) that is bent and broken off creating slivers.

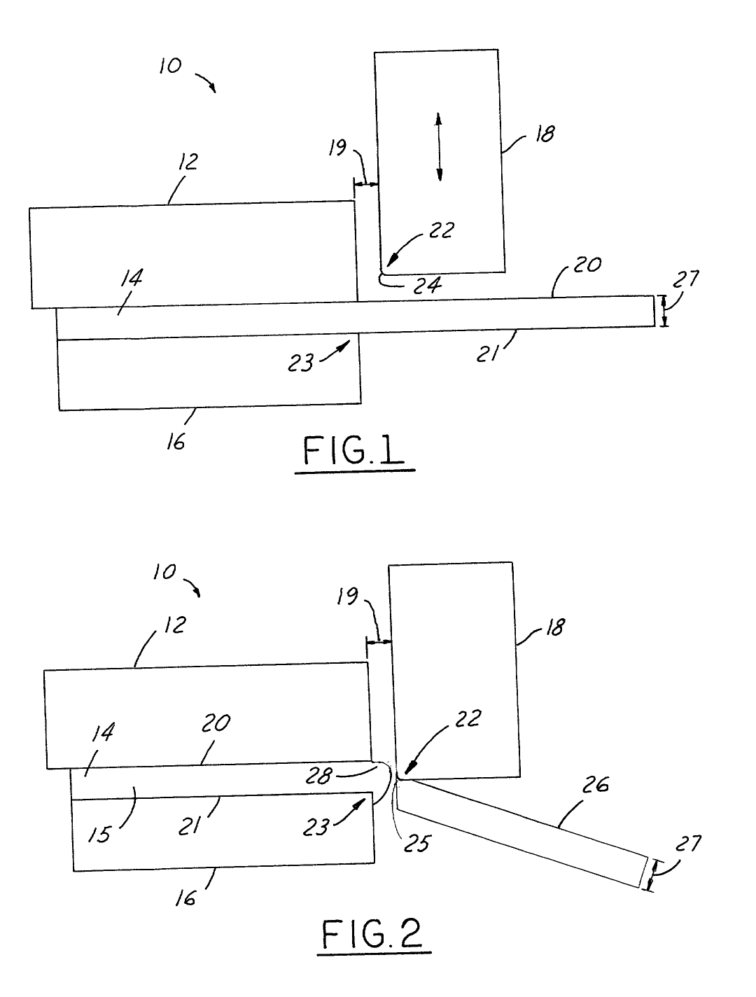

To eliminate this phenomena the present invention further includes a radius 24 formed into the leading edge 22 of the moving blade 18. By forming a radius 24 on the leading edge 22 of the moving blade 18, the strain experienced by the blank 14 is distributed in a wider area than when compared to the use of a sharp edge in the prior art. Although the cracking still develops away from the moving blade 18, the tongue 25 has a bigger cross-section and is strong enough to stay on the scrap 26 when the scrap 26 is being bent down and separated from the blank 14 (see FIG. 2). This results in a reduction in the production of slivers. It is preferable that the radius 24 be several times less than the blank thickness 27. In one embodiment, for illustrative purposes only, the blank thickness 27 is 0.93 mm and the radius 24 is 0.12 mm. Although a blank thickness 27 and radius 24 have been described, it should be understood that a vast array of radii can be used in conjunction with differing blank thickness and blank materials may be utilized.

In alternate embodiments, the present invention can impact an even wider variety of defects. In addition to slivers, trimming defects such as burrs and other surface faults that may result in post-trimming defects such as splits may also be reduced. Most materials have a higher ductility in the compressive stress state than in tensile. Therefore, bending the scrap 26 (as shown in FIG. 2) forces the cracking on the upper surface 20 to dominate. Cracking starting on the upper surface 20 from the moving blade 18 generates burrs 28 proportional to the gap 19 that remain on the part side of the trimmed surface 15. It is preferable, however, to have the cracking start from the steady blade 16 so that any burrs 28 remain on the scrap 26.

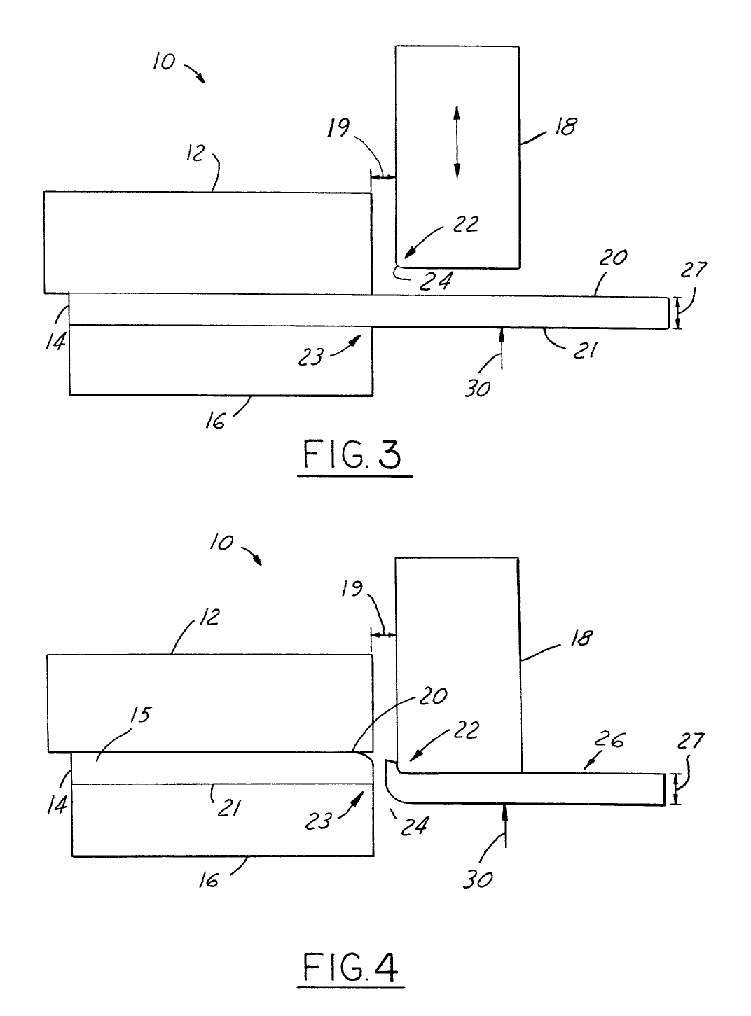

The present embodiment accomplishes this objective by including a support element 30 (see FIG. 3). The support element 30 reduces the bending of the blank 14 and scrap 26 by forcing the scrap 26 to move parallel to its initial position without rotating (see FIG. 4). This provides equivalent conditions from the moving blade 18 and the steady blade 16 for fracture. The present embodiment further includes the radius 24 formed into the leading edge 22 of the moving blade 18. The radius 24 decreases the concentration of strains on the upper surface 20 and creates a preference for fracture development from the steady blade 16. This results in a much larger range of gaps 19 than is possible in the prior art while continuing to reduce the production of burrs 28 and other surface defects on the usable blank 14.

In addition to a wider range of gaps 19, the present embodiment reduces the horizontal forces, due to the parallel movement of the scrap 26, from the prior art that resulted in the separation of the tongues. The radius 24 of the moving blade 18 also keeps the grain structure of the tongue similar in structure to other areas of the scrap 26. This combination of grain structure and elimination of horizontal forces combine to further reduce the production of slivers. Finally, the present embodiment preserves the blanks 14 ductility along the trim line as compared to the prior art and thereby further enhances the blank's 14 usefulness.

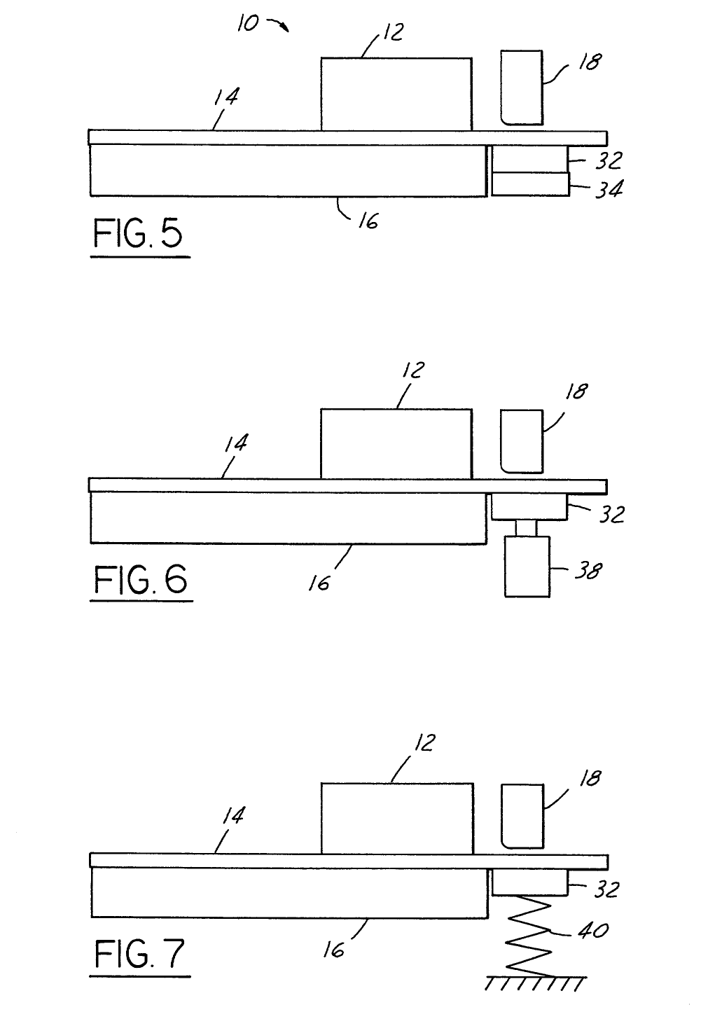

It is contemplated the support element 30 may take on a variety of forms. In one embodiment (see FIG. 5), the support element 30 consists of a steel plate 32 and an elastic pad 34. In a second embodiment (FIG. 6), the support element 30 consists of a steel plate 32 and a hydraulic (or gas) cylinder 38. Finally, in a third embodiment (see FIG. 7), the support element 30 consists of a steel plate 32 and a spring element 40. Although three embodiments have been described, it should be understood that a wide variety of support elements 30 are contemplated by the present invention. In each embodiment, the support element 30 supports the scrap 26, while permitting the scrap 26 to be moved downward while remaining parallel to its original position. The support element 30 acts to reduce the amount of bending in the scrap 26 during the trimming process. This in turn reduces the production of defects during the trimming process. Additionally, the support element 30 helps retain the material ductility of the metal blank 14 along the trim line. This provides an improved quality for the trimmed surfaces of the metal blank 14.

Although at least one embodiment of the present invention has been described in terms of a clamping pad 12, a steady blade 16, a moving blade 18 with a radius 24,and a support element 30, it should be understood that the use of a blade with a radius 24 and/or a support element 30 to reduce the production of defects may be practiced in a variety of configurations.

While particular embodiments of the invention have been shown and described, numerous variations and alternative embodiments will occur to those skilled in the art. Accordingly, it is intended that the invention be limited only in terms of the appended claims.

What is claimed is:

1. An apparatus for trimming scrap from a blank comprising:
a steady blade;
a clamping pad securing the blank to said steady blade;
a moving blade movable past said steady blade for trimming the blank;
a radius formed on the leading edge of said moving blade adapted to reduce defects in the blank associated with the trimming process; and
a support element in communication with the scrap and adapted to reduce defects in the blank associated with the trimming process.

2. An apparatus as described in claim 1 wherein said support element reduces bending in the scrap.

3. An apparatus as described in claim 1, wherein said support element maintains the scrap substantially parallel to its original orientation.

4. An apparatus as described in claim 1, wherein said support element comprises:
a plate; and
an elastic pad.

5. An apparatus as described in claim 1, wherein said support element comprises:
a plate; and
a hydraulic cylinder.

6. An apparatus as described in claim 1, wherein said support element comprises:
a plate; and
a spring element.

7. An apparatus as described in claim 1 for use with aluminum alloy blanks.

8. An apparatus as described in claim 1 for use in an automated stamping apparatus.

9. An apparatus for trimming scrap from a metal blank comprising:
a steady blade;
a clamping pad for securing the blank to said steady blade; and
a moving blade movable past said steady blade for trimming the blank; and
a radius formed on the leading edge of said moving blade adapted to reduce defects in the blank associated with the trimming process.

10. An apparatus as described in claim 9 for use with aluminum alloy blanks.

11. An apparatus as described in claim 9 for use in an automated stamping process.

12. A method of reducing the production of defects during trimming operations comprising:
holding a blank between a steady blade and a clamping pad;
moving a moving blade past said steady blade to trim scrap off of said blank; and
supporting said scrap to reduce defects in said blank associated with the trimming process.

13. A method as described in claim 12 wherein said supporting said scrap comprises:
preventing bending in said scrap during the trimming process.

14. A method as described in claim 13 wherein said supporting said scrap comprises:
keeping said scrap substantially parallel to said scrap's original orientation during the trimming process.

15. A method as described in claim 12 further comprising:
reducing the strain concentration caused by said moving blade on said blank through the use of a radius formed on the leading edge of said moving blade.

16. A method of reducing the production of defects during trimming operations comprising:
holding a blank between a steady blade and a clamping pad;
moving a moving blade past said steady blade to trim scrap off of said blank; and
reducing the strain concentration caused by said moving blade on said blank through the use of a radius formed on the leading edge of said moving blade.
